(19) United States
(12) Patent Application Publication
(10) Pub. No.: US 2026/0192796 A1
(43) Pub. Date: Jul. 9, 2026

(54) AUTOMATED VALET PARKING SYSTEM AND CHECK-IN METHOD

(71) Applicant: TOYOTA JIDOSHA KABUSHIKI KAISHA, Toyota-shi (JP)

(72) Inventors: Kazuhito ESHIMA, Toyota-shi (JP); Hidenobu Kinugasa, Nagoya-shi (JP); Takahiro Yamamoto, Toyota-shi (JP); Tatsuya Sugano, Seto-shi (JP)

(73) Assignee: TOYOTA JIDOSHA KABUSHIKI KAISHA, Toyota-shi (JP)

(21) Appl. No.: 19/396,045

(22) Filed: Nov. 20, 2025

(30) Foreign Application Priority Data
Jan. 6, 2025 (JP) 2025-001887

(51) Int. Cl. B60W 30/06; G06Q 10/02

(52) U.S. Cl. CPC B60W 30/06; G06Q 10/02; B60W 2556/45

(57) ABSTRACT

The target vehicle is a vehicle in which a reserved user uses automated valet parking in a parking lot. The check-in procedure is a procedure for confirming the intention of using the automated valet parking reserved in the parking lot. The automated valet parking system calculates a degree of certainty that the target vehicle reaches the parking lot based on the vehicle information including the position of the target vehicle and the parking lot information including the position of the parking lot before the check-in procedure. When the certainty level is equal to or greater than the threshold value, the automated valet parking system causes the management system that manages the automated valet parking to request a check-in procedure from the target vehicle or the user terminal of the user.

### CROSS-REFERENCE TO RELATED APPLICATION

This application claims priority to Japanese Patent Application No. 2025-001887 filed on January 6, 2025. The disclosure of the above-identified application, including the specification, drawings, and claims, is incorporated by reference herein in its entirety.

### BACKGROUND

### 1. Technical Field

The present disclosure relates to automated valet parking (AVP) of vehicles in a parking lot.

### 2. Description of Related Art

German Patent Application Publication No. 102012222562 discloses AVP in a parking lot. A vehicle corresponding to the AVP acquires route information from a parking lot system, and autonomously travels along the acquired route.

### SUMMARY

Automated valet parking of vehicles in a parking lot is considered. A user of a vehicle makes a reservation of automated valet parking in the parking lot. After making the reservation, the vehicle carrying the user arrives at the parking lot. It is assumed that a check-in procedure is required when the vehicle arrives at the parking lot. The check-in procedure is a procedure for confirming the intention to use the reserved automated valet parking in the parking lot. However, the check-in procedure for the automated valet parking has not been sufficiently studied.

A first aspect relates to an automated valet parking system for automated valet parking in a parking lot. The automated valet parking system includes one or more processors. A target vehicle is a vehicle that is used by a user that has reserved the automated valet parking in the parking lot. A check-in procedure is a procedure for confirming an intention to use the reserved automated valet parking in the parking lot. The one or more processors are configured to before the check-in procedure, calculate a degree of certainty that the target vehicle reaches the parking lot based on vehicle information including a position of the target vehicle and parking lot information including a position of the parking lot. When the degree of certainty is equal to or more than a threshold value, the one or more processors cause a management system that manages the automated valet parking to request the check-in procedure from the target vehicle or a user terminal of the user. When the degree of certainty is less than the threshold value, the one or more processors allow the target vehicle or the user terminal to request the check-in procedure in advance with the management system.

A second aspect relates to a check-in method to be executed by a computer and applied to automated valet parking in a parking lot. A target vehicle is a vehicle that is used by a user that has reserved the automated valet parking in the parking lot. A check-in procedure is a procedure for confirming an intention to use the reserved automated valet parking in the parking lot. The check-in method includes: before the check-in procedure, calculating a degree of certainty that the target vehicle reaches the parking lot based on vehicle information including a position of the target vehicle and parking lot information including a position of the parking lot; when the degree of certainty is equal to or more than a threshold value, causing a management system that manages the automated valet parking to request the check-in procedure from the target vehicle or a user terminal of the user; and when the degree of certainty is less than the threshold value, allowing the target vehicle or the user terminal to request the check-in procedure in advance with the management system.

When the degree of certainty that the target vehicle reaches the parking lot is high, the management system of the parking lot requests a check-in procedure from the target vehicle or the user terminal. This makes it possible to promote a check-in procedure. In addition, automated valet parking can be started smoothly.

On the other hand, at a stage where the degree of certainty that the target vehicle reaches the parking lot is still low, the management system cannot request a check-in procedure. Instead, the target vehicle or the user terminal is allowed to request a check-in procedure with the management system. This means that advance check-in is possible. By performing the advance check-in, it is no longer necessary to queue for check-in or perform the check-in after the target vehicle arrives at the parking lot. As a result, automated valet parking can be started smoothly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing an outline of an automated valet parking system (AVP system);

FIG. 2 is a conceptual diagram for explaining an example of automated valet parking;

FIG. 3 is a conceptual diagram for explaining a process related to a check-in procedure;

FIG. 4 is a block diagram for explaining a process related to calculation of certainty;

FIG. 5 is a block-diagram illustrating an exemplary configuration of vehicles; and

FIG. 6 is a block diagram illustrating a configuration example of a back-end system.

### DETAILED DESCRIPTION OF EMBODIMENTS

Embodiments of the present disclosure will be described with reference to the accompanying drawings. In the following explanation, the automated valet parking may be referred to as "AVP".

### 1. Automated Valet Parking System (AVP System)

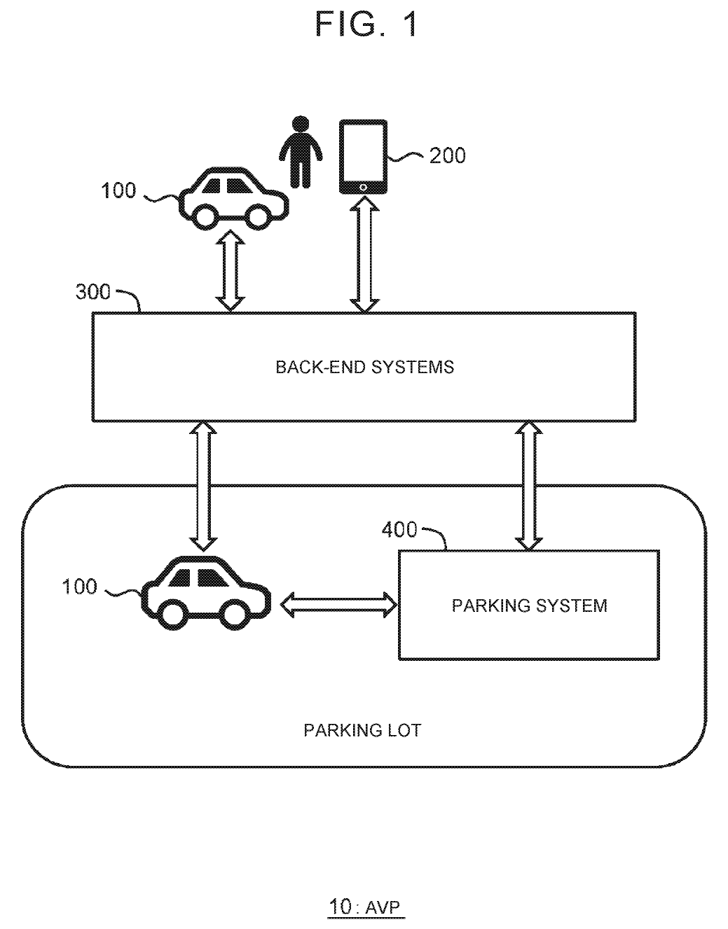

FIG. 1 is a conceptual diagram illustrating an outline of an AVP system 10 according to the present embodiment. AVP system 10 is a system for AVP in a parking lot. AVP system 10 includes vehicles 100, user terminals 200, a back-end system 300, and a parking lot system 400.

The vehicles 100 are targets of AVP in the parking lot, and correspond to AVP in the parking lot. The vehicle 100 has a function of autonomously traveling at least in a parking lot.

The user terminal 200 is a terminal operated by a user of AVP service-that is, the user of the vehicle 100. Examples of the user terminal 200 include a smart phone and a PC.

The back-end system 300 manages users of AVP, AVP services in one or more parking lots, AVP target vehicles 100, and the like. The parking lot system 400 is an infrastructure system installed in a certain parking lot, and manages AVP in the parking lot. The back-end system 300 and the parking lot system 400 may be collectively referred to as a "management system." The management system manages AVP in the parking lot.

The vehicle 100 and the back-end system 300 may communicate with each other. For example, the vehicle 100 and the back-end system 300 communicate with each other using a mobile communication service. In addition, in the parking lot, the vehicle 100 and the parking lot system 400 can perform wireless communication with each other. For example, the vehicles 100 and the parking lot system 400 perform wireless communication with each other by using wireless LAN. The vehicle 100 and the user terminal 200 can also perform wireless communication. In addition, the user terminal 200 and the back-end system 300 can communicate with each other. For example, the user terminal 200 and the back-end system 300 communicate with each other using a mobile communication service. Further, the back-end system 300 and the parking lot system 400 may communicate with each other in a wired or wireless manner.

An exemplary flow of AVP servicing is as follows. It is assumed that the member information of the user is registered in advance in the back-end system 300. First, the user reserves an AVP. For example, the user operates the user terminal 200 to enter ID of the user, a desired parking lot, a desired use date, a desired use time (a scheduled warehousing time and a scheduled delivery time), and the like. The user terminal 200 transmits reservation request information including the input information to the back-end system 300. The back-end system 300 performs a reservation process based on the reservation request information, and transmits a reservation completion notification to the user terminal 200. The back-end system 300 also provides reservation information to the parking lot system 400 of the reserved parking lot.

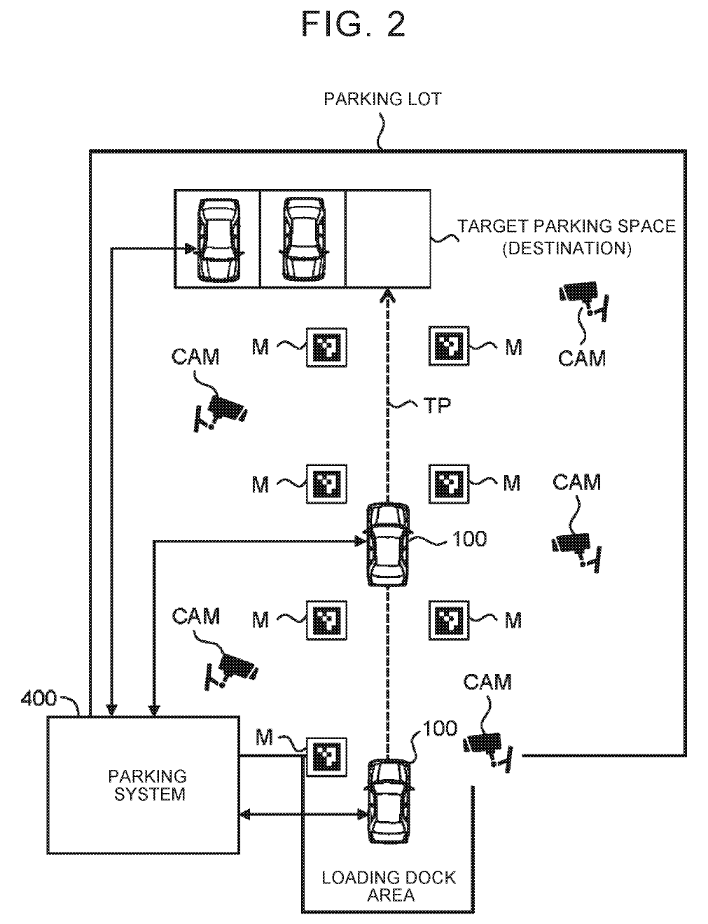

FIG. 2 is a conceptual diagram for explaining an exemplary AVP in a parking lot.

The vehicle 100 recognizes a situation around the vehicle 100 using a recognition sensor (e.g., a camera) mounted on the vehicle 100. The vehicle 100 safely travels while recognizing the surrounding situation. A plurality of markers M may be arranged in the parking lot. For example, the vehicle 100 recognizes the surrounding marker M using a camera, and estimates the vehicle position in the parking lot with high accuracy based on the recognition result of the marker M (Localization). Then, the vehicle 100 automatically travels in the parking lot based on the estimated vehicle position.

One or more infrastructure camera CAM may be installed in the parking lot. The infrastructure camera CAM captures an image of the parking lot and acquires an image indicating a status of the parking lot. The parking lot system 400 communicates with the infrastructure camera CAM to obtain images captured by the infrastructure camera CAM. The parking lot system 400 detects the vehicle 100 in the image by analyzing the image. In addition, the parking lot system 400 estimates the position of the vehicle 100 in the image. Further, the parking lot system 400 manages each vehicle 100 in the parking lot based on the position of each vehicle 100. The parking lot system 400 may provide location information of the vehicle 100 to the vehicle 100. The vehicle 100 may automatically travel in the parking lot based on location information provided by the parking lot system 400.

An example of the warehousing process is as follows. The vehicle 100 stops in the warehousing area. In the warehousing area, the user gets out of the vehicle 100 and requests warehousing using the user terminal 200 or the like. The management system (at least one of the back-end system 300 and the parking lot system 400) authenticates the user or the vehicle 100. When the authentication is completed, the operation authority of the vehicle 100 is transferred from the user to the management system. The management system communicates with the vehicle 100 to activate the vehicle 100. In addition, the parking lot system 400 allocates an empty parking frame to the vehicle 100. The allocated free parking frame serves as a target parking frame, that is, a destination for the vehicle 100 at the time of warehousing. Further, the parking lot system 400 sets a travel route TP (target trajectory) from the entry area to the target parking frame in the parking lot. The parking lot system 400 transmits an entry instruction to the vehicle 100. The warehousing instruction includes the target parking frame and the travel route TP. In response to the warehousing instruction, the vehicles 100 automatically travel to the target parking frame in accordance with the travel route TP. That is, the vehicle 100 automatically travels to follow the travel route TP based on the vehicle position. Then, the vehicle 100 automatically parks in the target parking frame. After the parking is completed, the management system instructs the vehicle 100 to stop the operation.

An example of the delivery processing is as follows. The user requests retrieval using the user terminal 200 or the like. The management system communicates with the vehicle 100 and activates the vehicle 100. At the time of delivery, the designated delivery area serves as a destination for the vehicle 100. The parking lot system 400 sets a travel route TP (target trajectory) from the parking frame to the exit area in the parking lot. The parking lot system 400 transmits a delivery instruction to the vehicle 100. The shipping instruction includes information about the designated shipping area and travel route TP. In response to the delivery instruction, the vehicles 100 automatically travel to the delivery area in accordance with the travel route TP. That is, the vehicle 100 automatically travels to follow the travel route TP based on the vehicle position. Then, the vehicle 100 automatically stops in the delivery area. The operation authority of the vehicle 100 moves from the management system to the user. The user gets into the vehicle 100. Vehicle 100 starts to the next destination.

### 2. Check-in procedure

As described above, the user reserves an AVP in the parking lot. The vehicle 100 in which the reserved user uses AVP in the parking lot is hereinafter referred to as a target vehicle 100T. It is assumed that a "check-in procedure" is required when the target vehicle 100T carrying the user arrives at the parking lot. The check-in procedure is a procedure for confirming the intention to use AVP reserved in the parking lot. The check-in procedure may be a final check-in procedure prior to commencement of AVP. There is room for further consideration of the check-in procedure.

### 2-1. Comparative Example

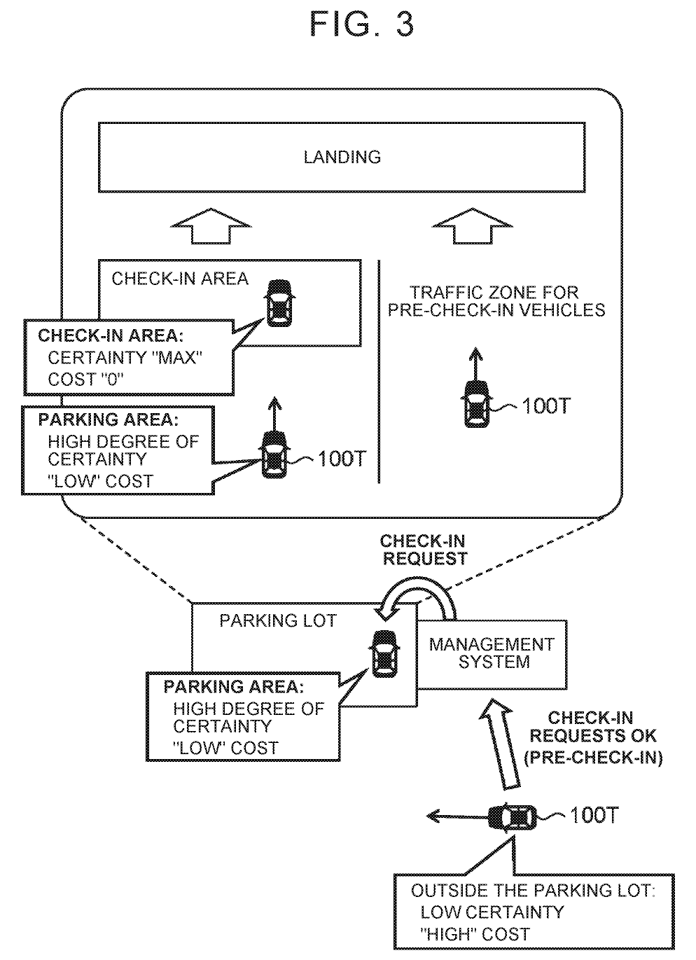

First, a comparative example will be described. The parking lot is provided with a check-in area and a boarding and disembarking area (see FIG. 3). The check-in area is located at the front of the landing. In the comparative example, the check-in procedure (the procedure for confirming the intention to use AVP) is performed only in the check-in area.

For example, the management system (the back-end system 300 and the parking lot system 400) maintains a correspondence relation between the user ID of the user and the vehicle ID of the target vehicle 100T. ID of vehicles is, for example, information of a license plate. At the reservation stage, the management system can grasp the vehicle ID of the target vehicle 100T from the user ID included in the reservation data. Thereafter, the target vehicle 100T carrying the user stops in the check-in area. The management system recognizes that the target vehicle 100T has arrived at the check-in area by recognizing the vehicle ID of the target vehicle 100T using the infrastructure camera CAM installed in the parking lot. The fact that the target vehicle 100T has arrived at the check-in area in the parking lot means that the use of AVP is reliable. That is, recognizing that the target vehicle 100T has arrived in the check-in area corresponds to the check-in procedure.

As another example, after the target vehicle 100T stops in the check-in area, the user may manually perform the check-in procedure. For example, the user operates the user terminal 200 to notify the management system that the user has arrived in the check-in area. According to a notification from the user, the management system recognizes that the target vehicle 100T has reached the check-in area.

After the completion of the check-in procedure, the target vehicle 100T carrying the user proceeds to the landing. At the landing, the user gets out of the target vehicle 100T. The user then requests an AVP initiation. For example, the user operates the user terminal 200 to request AVP initiation. The management system receives AVP initiation request from the user, and initiates AVP of the target vehicles 100T in response to the AVP initiation request.

### 2-2. Promotion of check-in procedures

FIG. 3 is a conceptual diagram for explaining a process related to a check-in procedure according to the present embodiment. According to the present embodiment, a "check-in request" is newly introduced in order to promote the check-in procedure. The check-in request is a trigger of a check-in procedure and can be issued regardless of the position of the target vehicle 100T. That is, the check-in request enables the check-in procedure regardless of the position of the target vehicle 100T.

The entity issuing the check-in request depends on the situation. For example, if the target vehicle 100T has arrived at the parking lot, it is almost certain that the target vehicle 100T uses AVP reserved in the parking lot. In this instance, the management system (back-end system 300) may actively issue a check-in request to the target vehicle 100T or the user terminal 200. That is, the management system (back-end system 300) may actively request the target vehicle 100T or the user terminal 200 to perform a check-in procedure. Upon receiving the check-in request, the target vehicle 100T executes a check-in procedure. For example, the target vehicle 100T transmits a confirmation notification for confirming the use of AVP in the parking lot to the management system. The target vehicle 100T may automatically transmit the confirmation notification to the management system, or may transmit the confirmation notification to the management system after obtaining the user's approval. Similarly, the user terminal 200 that has received the check-in request executes a check-in procedure. For example, the user terminal 200 notifies the user that the check-in request has been received. When the user approves the check-in procedure, the user terminal 200 transmits a confirmation notification confirming the use of AVP in the parking lot to the management system. This may facilitate a check-in procedure. In addition, automated valet parking can be started smoothly.

On the other hand, if the target vehicle 100T is still away from the parking lot, it is still not certain that the target vehicle 100T will use AVP reserved in the parking lot. Therefore, a check-in procedure cannot be requested from the management system. Instead, a check-in procedure is permitted from the target vehicle 100T or user terminal 200 to the management system. The management system that has received the check-in request can confirm in advance that the target vehicle 100T uses the reserved AVP in the parking lot. This means that pre-check-in is possible. By performing the pre-check-in, it becomes unnecessary to arrange the target vehicle in the check-in line or perform the check-in procedure after the target vehicle arrives at the parking lot. As a result, automated valet parking can be started smoothly. As shown in FIG. 3, a "pre-check-in vehicle traffic zone" that does not pass through the check-in area may be provided in the parking lot.

### 2-3. Calculation of certainty

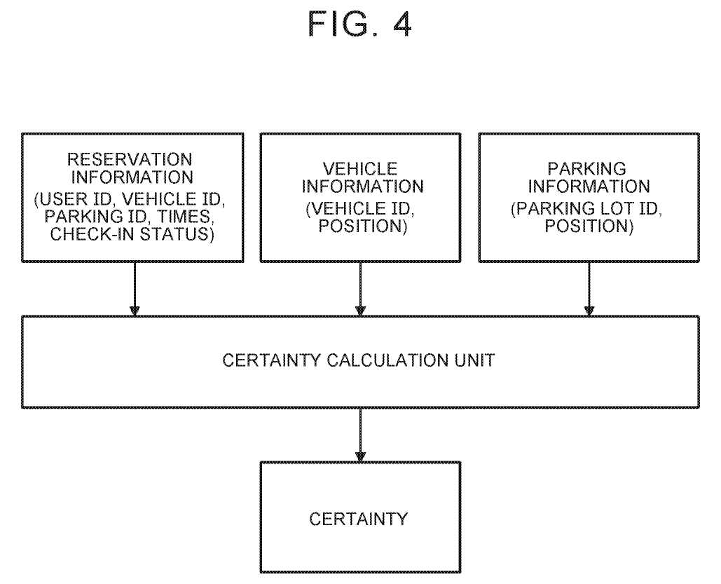

AVP system 10 calculates the degree of certainty that the target vehicle 100T reaches the reserved parking lot. FIG. 4 is a block diagram for explaining a process related to calculation of certainty. AVP system 10 includes a certainty calculation unit. The certainty calculation unit calculates certainty before the check-in procedure. The certainty calculation unit may be included in the management system (the back-end system 300 or the parking lot system 400), may be included in the vehicle 100 (target vehicle 100T), or may be included in the user terminal 200.

The reservation information is information related to a reservation of an AVP in a parking lot. As described above, the user operates the user terminal 200 to enter a user ID, a desired parking lot, a desired use date, a desired use time (a scheduled warehousing time and a scheduled delivery time), and the like. The user terminal 200 transmits reservation request information including the input information to the back-end system 300. The back-end system 300 maintains a correspondence relation between the user ID of the user and the vehicle ID of the target vehicle 100T. ID of vehicles is, for example, information of a license plate. The back-end system 300 can recognize the vehicle ID of the target vehicle 100T from the user ID. The reserved information includes a user ID, a vehicle ID, a parking lot ID, a desired usage date, a desired usage duration, a check-in status, and the like. The reservation information may be provided to the target vehicle 100T, the user terminal 200, and the parking lot system 400.

The vehicle information is information about each vehicle 100. Vehicle information includes the vehicle ID, vehicle position, vehicle velocity, and the like of the respective vehicles 100. The vehicle information is obtained from the vehicle 100. The vehicle information may be provided to the user terminal 200, the back-end system 300, and the parking lot system 400.

The parking lot data indicates a parking lot ID and a parking lot position for each parking lot. The parking lot information is obtained from the management system (the back-end system 300 or the parking lot system 400). The parking lot data may be provided to the user terminal 200 or the target vehicle 100T.

Prior to the check-in procedure, the certainty degree calculation unit calculates a certainty degree to which the target vehicle 100T reaches the reserved parking lot. More specifically, the certainty degree calculation unit calculates the certainty degree based on the reservation information, the vehicle information, and the parking lot information. For example, the certainty degree calculation unit recognizes the correspondence between the vehicle ID of the target vehicle 100T and the reserved parking lot ID based on the reservation information. Subsequently, the certainty degree calculation unit acquires the vehicle position associated with the vehicle ID, that is, the vehicle position of the target vehicle 100T, based on the vehicle information. The certainty calculation unit may acquire the vehicle position and the vehicle velocity of the target vehicle 100T based on the vehicle data. Further, the certainty degree calculation unit acquires the parking lot position associated with the parking lot ID based on the parking lot data. Then, the certainty degree calculation unit calculates a certainty degree that the target vehicle 100T reaches the parking lot based on the vehicle position of the target vehicle 100T and the parking lot position.

For example, the certainty degree calculation unit predicts a time required for the target vehicle 100T to reach the parking lot based on the vehicle position of the target vehicle 100T and the parking lot position. The certainty calculation unit may also take the vehicle velocity of the target vehicle 100T into account to predict the time it takes for the target vehicle 100T to reach the parking lot. The longer the expected time, the lower the certainty. If the target vehicle 100T is in a parking lot, the certainty level is the first level. On the other hand, when the target vehicle 100T is still outside the parking lot, the certainty level is a second level lower than the first level. The certainty can be said to be a reversal of the cost of arrival.

### 2-4. Check-in request

AVP system 10 sets an entity that issues a check-in request according to the above-described certainty level. More specifically, when the degree of certainty is equal to or greater than the predetermined threshold value, AVP system 10 causes the management system (back-end system 300) to issue a check-in request to the target vehicle 100T or the user terminal 200. Upon receiving the check-in request, the target vehicle 100T executes a check-in procedure. For example, the target vehicle 100T transmits a confirmation notification for confirming the use of AVP in the parking lot to the management system. The target vehicle 100T may automatically transmit the confirmation notification to the management system, or may transmit the confirmation notification to the management system after obtaining the user's approval. Similarly, the user terminal 200 that has received the check-in request executes a check-in procedure. For example, the user terminal 200 notifies the user that the check-in request has been received. When the user approves the check-in procedure, the user terminal 200 transmits a confirmation notification confirming the use of AVP in the parking lot to the management system. This may facilitate a check-in procedure. In addition, automated valet parking can be started smoothly.

On the other hand, when the degree of certainty is less than the predetermined threshold value, AVP system 10 permits the management system to issue a check-in request from the target vehicle 100T or the user terminal 200. The management system that has received the check-in request can confirm in advance that the target vehicle 100T uses the reserved AVP in the parking lot. This means that pre-check-in is possible. By performing the pre-check-in, it becomes unnecessary to arrange the target vehicle in the check-in line or perform the check-in procedure after the target vehicle arrives at the parking lot. As a result, automated valet parking can be started smoothly.

As described above, when the target vehicle 100T is in the parking lot, the certainty level is the first level. On the other hand, when the target vehicle 100T is still outside the parking lot, the certainty level is a second level lower than the first level. The predetermined threshold may be set between the first level and the second level.

When a temporary communication error occurs, there is a possibility that the above-described check-in request does not reach the communication partner. In such cases, the target vehicle 100T may arrive at the check-in area in the parking lot without performing the check-in procedure due to the check-in request. If the target vehicle 100T has arrived in the check-in area and the check-in procedure has not yet been executed, AVP system 10 may send a notification to the user terminal 200 prompting the check-in procedure. The user operates the user terminal 200 to notify the management system that the user has arrived in the check-in area. According to a notification from the user, the management system recognizes that the target vehicle 100T has reached the check-in area.

### 3. Configuration example of the vehicle

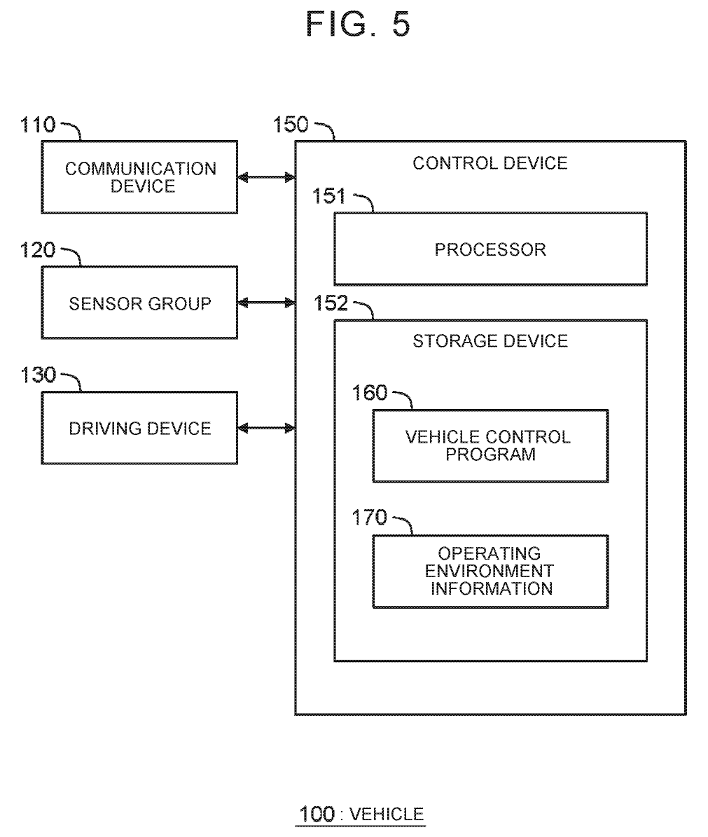

FIG. 5 is a block diagram illustrating a configuration example of the vehicle 100 according to the present embodiment. The vehicle 100 includes a communication device 110, a sensor group 120, a travel device 130, and a control device 150.

The communication device 110 communicates with the outside via a communication network. For example, the communication device 110 communicates with the back-end system 300. The communication device 110 communicates with the parking lot system 400 via a radio LAN. The communication device 110 may communicate with the user terminal 200.

The sensor group 120 includes a recognition sensor, a vehicle state sensor, and the like. The recognition sensor is used to recognize (detect) a situation around the vehicle 100. Examples of the recognition sensor include a camera, a lidar, and a radar. The vehicle state sensor includes a speed sensor, an acceleration sensor, a yaw rate sensor, a steering angle sensor, and the like.

The travel device 130 includes a steering device, a driving device, and a braking device. The steering device will turn the wheel. For example, the steering device includes a power steering device. The driving device is a power source that generates a driving force. Examples of the driving device include an engine, an electric motor, and an in-wheel motor. The braking device generates a braking force.

The control device 150 is a computer that controls the vehicle 100. The control device 150 includes one or more processors 151 and one or more storage devices 152. The processor 151 executes various processes. Exemplary processors 151 include general purpose processors, special purpose processors, CPU, GPU, ASIC, FPGA, integrated circuitry, and the like. The processor 151 may also be referred to as processing circuitry. The storage device 152 stores various types of information. Examples of the storage device 152 include a volatile memory, a nonvolatile memory, and a HDD, SSD.

The vehicle control program 160 is a computer program for controlling the vehicle 100. The functions of the control device 150 may be realized by cooperation of the processor 151 executing the vehicle control program 160 and the storage device 152. The vehicle control program 160 is stored in the storage device 152. Alternatively, the vehicle control program 160 may be recorded in a computer-readable recording medium.

The control device 150 executes vehicle travel control for controlling travel of the vehicle 100. The vehicle travel control includes steering control, acceleration control, and deceleration control. The control device 150 executes vehicle travel control by controlling the travel device 130 (a steering device, a drive device, and a braking device).

The control device 150 communicates with the back-end system 300 and the parking lot system 400 via the communication device 110.

The control device 150 acquires the driving environment information 170 indicating the driving environment of the vehicle 100. The driving environment information 170 is stored in the storage device 152. For example, the driving environment information 170 includes surrounding situation information, vehicle state information, map information, position information, and the like.

The surrounding situation information indicates a recognition result by the recognition sensor. The surrounding situation information may include object information about an object recognized by the recognition sensor. Examples of the object around the vehicle 100 include an obstacle, a white line, and a marker M. Examples of the obstacle include a wall, a column, and another vehicle. The object information indicates a relative position and a relative speed of the object with respect to the vehicle 100.

The vehicle state information indicates a vehicle state detected by the vehicle state sensor. Examples of the vehicle state include speed, acceleration, yaw rate, steering angle, and the like.

The map information is map information of a parking lot in which the vehicle 100 travels. The map information indicates the arrangement of roads in the parking lot. In addition, the map information indicates the arrangement of stationary obstacles (e.g., walls and columns) in the parking lot. Further, the map information indicates the arrangement of the markers M in the parking lot. For example, the map information is provided from the parking lot system 400 that manages the parking lot. The control device 150 acquires map information from the parking lot system 400 via the communication device 110.

The position information indicates a current position of the vehicle 100 in the parking lot. For example, the control device 150 acquires highly accurate position information by localization processing. Specifically, the control device 150 calculates a rough position of the vehicle 100 in the parking lot based on the vehicle state information (steering angle and speed). In addition, the control device 150 recognizes the marker M around the vehicle 100 using the recognition sensor. Further, the control device 150 acquires the arrangement information of the markers M around the vehicle 100 from the map information. The control device 150 corrects the position of the vehicle 100 by matching the recognition result of the marker M with the arrangement. Thus, highly accurate position information is obtained.

Alternatively, the location of the vehicles 100 may be estimated by the parking lot system 400 based on images captured by the infrastructure camera CAM. In this case, the control device 150 may acquire the position information from the parking lot system 400 via the communication device 110.

In addition, the control device 150 acquires the travel route TP in the parking lot. For example, the travel route TP is determined by the parking lot system 400, and the control device 150 acquires the travel route TP from the parking lot system 400 via the communication device 110. Alternatively, the control device 150 may determine the travel route TP based on the map information and the position information. Then, the control device 150 executes vehicle travel control so that the vehicle 100 travels in accordance with the travel route TP based on the position data.

The control device 150 may have a function of the above-described certainty calculation unit. In this case, the control device 150 acquires the reservation information and the parking lot information from the management system (the back-end system 300). Then, the control device 150 calculates the certainty based on the position information of the vehicle 100, the vehicle state information (vehicle speed), the reservation information, and the parking lot information. The control device 150 may provide the calculated certainty information to the management system (the back-end system 300) or the user terminal 200 via the communication device 110.

In addition, the control device 150 may have a function of issuing a check-in request. More specifically, when the degree of certainty is less than the predetermined threshold value, the control device 150 may transmit a check-in request to the management system (back-end system 300) via the communication device 110.

Furthermore, the control device 150 may have a function of responding to a check-in request. More specifically, the control device 150 receives a check-in request from the management system (back-end system 300) via the communication device 110. In response to the check-in request, the control device 150 transmits a confirmation notification to the management system (back-end system 300) via the communication device 110.

### 4. Back-end system configuration example

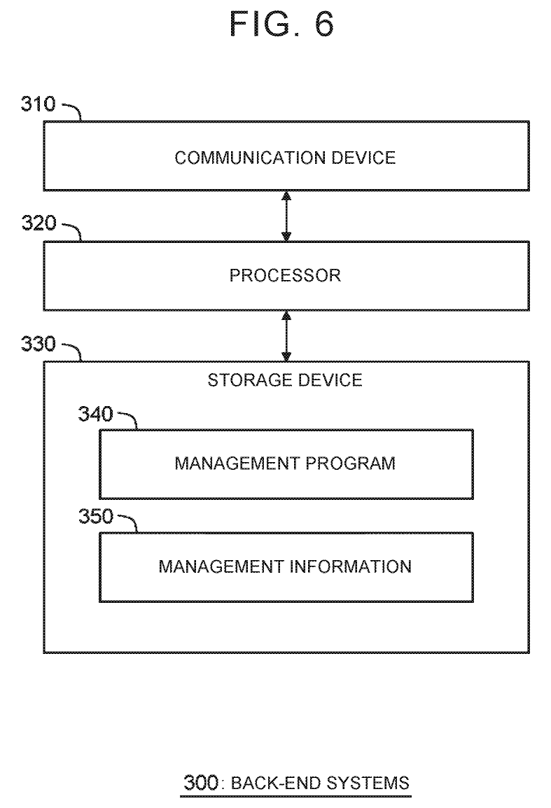

FIG. 6 is a block diagram illustrating a configuration example of the back-end system 300 according to the present embodiment. The back-end system 300 includes a communication device 310, one or more processors 320 (hereinafter simply referred to as processors 320), and one or more storage devices 330 (hereinafter simply referred to as storage devices 330).

The communication device 310 communicates with each vehicle 100. The communication device 310 communicates with the user terminals 200 of the respective users. Furthermore, the communication device 310 communicates with the parking lot system 400 of each parking lot.

The processor 320 executes various processes. Exemplary processors 320 include general purpose processors, special purpose processors, CPU, GPU, ASIC, FPGA, integrated circuitry, and the like. The processor 320 may also be referred to as processing circuitry. The storage device 330 stores various types of information. Examples of the storage device 330 include a volatile memory, a nonvolatile memory, and a HDD, SSD.

The management program 340 is a computer program for managing AVP in the parking lot. The functions of the back-end system 300 may be realized by cooperation of the processor 320 executing the management program 340 and the storage device 330. The management program 340 is stored in the storage device 330. The management program 340 may be recorded in a computer-readable recording medium.

The storage device 330 stores management information 350. The management information 350 may include user information about each user. The management information 350 may include reservation information and parking lot information (see FIG. 4).

The processor 320 communicates with the vehicle 100, the user terminal 200, and the parking lot system 400 via the communication device 310.

The processor 320 may have a function of the certainty calculation unit described above. Then, the processor 320 acquires the vehicle information from the target vehicle 100T via the communication device 310. Then, the processor 320 calculates the certainty based on the vehicle information and the management information 350. The processor 320 may provide the calculated certainty information to the target vehicle 100T or the user terminal 200 via the communication device 310.

The processor 320 may include a function of issuing a check-in request. More specifically, when the certainty level is equal to or greater than the predetermined threshold value, the processor 320 may transmit a check-in request to the target vehicle 100T or the user terminal 200 via the communication device 310.

The processor 320 may receive a check-in request from the target vehicle 100T or the user terminal 200 via the communication device 310.

What is claimed is:

1. An automated valet parking system for automated valet parking in a parking lot, comprising one or more processors,
a target vehicle being a vehicle that is used by a user that has reserved the automated valet parking in the parking lot, and
a check-in procedure being a procedure for confirming an intention to use the reserved automated valet parking in the parking lot, wherein
the one or more processors are configured to:
before the check-in procedure, calculate a degree of certainty that the target vehicle reaches the parking lot based on vehicle information including a position of the target vehicle and parking lot information including a position of the parking lot;
when the degree of certainty is equal to or more than a threshold value, cause a management system that manages the automated valet parking to request the check-in procedure from the target vehicle or a user terminal of the user; and
when the degree of certainty is less than the threshold value, allow the target vehicle or the user terminal to request the check-in procedure in advance with the management system.

2. The automated valet parking system according to claim 1, wherein:
the degree of certainty is a first level when the target vehicle is in the parking lot;
the degree of certainty is a second level that is lower than the first level when the target vehicle is outside the parking lot; and
the threshold value is between the first level and the second level.

3. The automated valet parking system according to claim 1, wherein when the target vehicle has arrived at a check-in area in the parking lot and the check-in procedure has not been executed yet, the one or more processors transmit a notification to prompt the user terminal of the user to the check-in procedure.

4. A check-in method to be executed by a computer and applied to automated valet parking in a parking lot,
a target vehicle being a vehicle that is used by a user that has reserved the automated valet parking in the parking lot, and
a check-in procedure being a procedure for confirming an intention to use the reserved automated valet parking in the parking lot,
the check-in method comprising:
before the check-in procedure, calculating a degree of certainty that the target vehicle reaches the parking lot based on vehicle information including a position of the target vehicle and parking lot information including a position of the parking lot;
when the degree of certainty is equal to or more than a threshold value, causing a management system that manages the automated valet parking to request the check-in procedure from the target vehicle or a user terminal of the user; and
when the degree of certainty is less than the threshold value, allowing the target vehicle or the user terminal to request the check-in procedure in advance with the management system.
